(19) United States
(12) Patent Application Publication
(10) Pub. No.: US 2008/0292742 A1
(43) Pub. Date: Nov. 27, 2008

(54) Method for conveying polymer

(76) Inventor: James R. Ketchum, Santa Fe, TX (US)

Correspondence Address: LyondellBasell Industries, 3801 WEST CHESTER PIKE, NEWTOWN SQUARE, PA, 19073, US

(21) Appl. No.: 11/807,315

(22) Filed: May 25, 2007

(51) Int. Cl. B29C 47/10

(52) U.S. Cl. 425/377

(57) ABSTRACT

A method for transferring molten polymer through a chute having sharp internal corners, the chute bridging spaced apart processing units, wherein at least the internal corners of the chute are rounded and smoothed to at least a mirror shine.

### BACKGROUND OF THE INVENTION

1. Field of the Invention

This invention relates to a method of conveying molten polymer from a first processing apparatus to a second processing apparatus.

2. Description of the Prior Art

Although, for sake of clarity and brevity this invention is described in terms of conveying molten polyethylene, this invention is not limited to that type of polymer.

Ethylene is polymerized to polyethylene homopolymers and co-polymers by a number of different processes to make different polymeric products such as low density polyethylene, high density polyethylene, and linear low density polyethylene which exhibits favorable characteristics found in both low density and high density polyethylene. For sake of example only, this invention is described herein primarily in terms of a slurry phase (suspension) polymerization process for making high density polyethylene (HDPE).

The slurry polymerization process typically takes place in a closed loop (horizontal or vertical) reactor using a hydrocarbonaceous solvent such as n-hexane, isobutane, isopentane, and the like. The essentially liquid feed mixture of ethylene, co-monomer(s), if any, catalyst, and any additives is continuously pumped in a loop while the polymerization reaction takes place.

The process can employ known catalyst systems such as a silica-supported chromium/aluminum catalyst with or without a co-catalyst such as triethyleborane, or Ziegler-Natta catalyst systems comprised of titanium tetrachloride/trialkyl aluminum, or other transition metals such as zirconium and vanadium in place of the titanium. These catalyst systems are well known in the art and more detail is not necessary to inform one skilled in the art.

While the aforesaid feed mixture is continuously circulated in the loop reactor, polymerization takes place at temperatures below the melting point of the polyethylene formed thereby producing a slurry of solid polyethylene particles in the liquid feed mixture. The reaction typically takes place at a temperature of from about 185 to about 220 degrees Fahrenheit (F) at a pressure of from about 500 to about 650 psig. A slurry containing, among other things, HDPE and solvent is drawn off from the reactor either continuously or intermittently, as desired.

The loop reactors are normally formed from large diameter pipes, e.g., from about 10 to about 30 inches in inside diameter, and can be about 50 feet across with lengths of from about 250 to about 300 feet in length.

The slurry withdrawn from the reactor is processed for the removal of solvent for re-use in the reactor. The remaining solid polyethylene particles are then passed to a drying, extruding, and pelletizing system wherein the particles are converted to solid polyethylene pellets. The pellets are packaged and marketed as a product of the polyethylene production plant in which the foregoing process was carried out.

It is the mixer/extruder combination of apparatus in the drying, extruding, and pelletizing system to which this invention is directed.

A high shear mixer such as a fifteen inch Farrell continuous mixer has been employed in this system. The operation of the mixer unit was to receive solid polyethylene powder at a temperature of from about ambient to about 140 F, and to mix this powder until the mixing action raises the temperature of the powder to a temperature of from about 360 to about 420 F, thereby melting the powder and forming a stream of molten HDPE.

The molten polymer was then transferred through a normally upstanding (essentially vertical) chute/hopper conduit combination to an extruder unit in which the molten polymer was extruded as a first step toward making solid polymer pellets suitable for storage, packaging, and the like.

The conduit chute part of the aforesaid chute/hopper combination of molten polymer conveying conduits is an elongated, hollow member having a quadrilateral transverse cross-section, usually rectangular. This prior art chute was characterized by having multiple, sharp, concavely (inwardly) angled corners, e.g., four 90 degree angles in the case of a quadrilateral transverse cross-section, oriented to open toward the open, inner volume of the conduit.

It was found that molten polyethylene tended to hang up in the inner, sharp corners of the chute, and bake thereunder the normal elevated temperatures inside the chute until at least a portion of the stranded polymer's surface was discolored, e.g., blackened. Thereafter, at least a part of the blackened polymer tended to flake off into fresh, molten, essentially white polymer passing thereby in the chute. This flaking of darkened polymer into whitish polymer caused black spots to appear in the final pellet products. The presence of “black specs” in the pellet product either reduced the value of that particular product, or rendered it unmarketable, at least to certain customers.

Accordingly, it is desirable to have a chute that resists the hang up of polymer in the corners thereof. This invention meets that desire.

### SUMMARY OF THE INVENTION

Pursuant to this invention there is provided a chute, as described above, wherein the sharp corners are both rounded and smoothed to the extent described below.

It would appear that a chute with a round overall transverse cross-section would solve the problem of polymer hang up in the corners, but this was not an acceptable solution because the totally round configuration for the chute severely and unacceptably reduced the polymer flow-through capacity of the chute.

Pursuant to this invention, the solution to the problem is the combination of not only corner rounding, but also smoothing of the inner surface of at least the rounded corners that are exposed to flowing molten polymer to at least an ASTM R-12 (125 micron) level. This degree of smoothness is at least a level of mirror smoothness.

### BRIEF DESCRIPTION OF THE DRAWINGS

FIG. 1 shows a prior art arrangement of a first mixing apparatus and a second extruding apparatus bridged by a chute/hopper combination as described above.

FIG. 2 shows a transverse cross-section of the prior art chute of FIG. 1.

FIG. 3 shows the transverse cross-section of a chute that is within this invention.

FIG. 4 shows an enlargement of one of the rounded corners of the chute of FIG. 3.

### DETAILED DESCRIPTION OF THE INVENTION

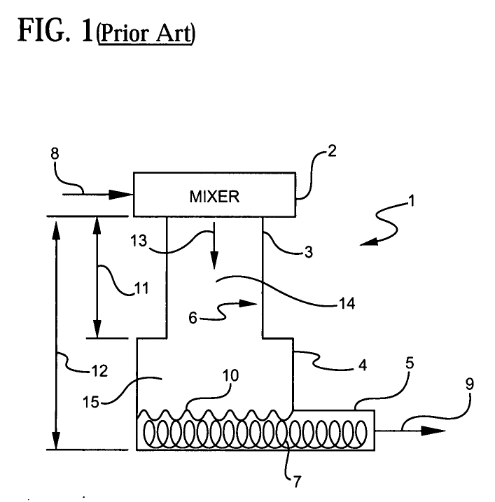

FIG. 1 shows an operative assembly 1 of an upper high shear mixer unit 2 and lower extruder unit 5 which are bridged in a molten polymer transfer manner by the use of a combination of hollow chute 3 and hollow hopper 4. Solid polymer powder 8 is passed into mixer 2 and therein mixed until the powder is raised to a temperature at which the powder becomes molten. The molten polymer then passes into the interior of chute 3 as shown by arrow 13.

Chute 3 receives the molten polymer from mixer 2 in its open interior, as defined by its inner wall surfaces 6, and transports it to the open interior of hopper 4. The molten polymer resides in hopper 4 until removed therefrom by the rotation of endless extruder screw 7. A string of extruded polymer is removed from extruder 5, as shown by arrow 9, ready for the pelletizing operation.

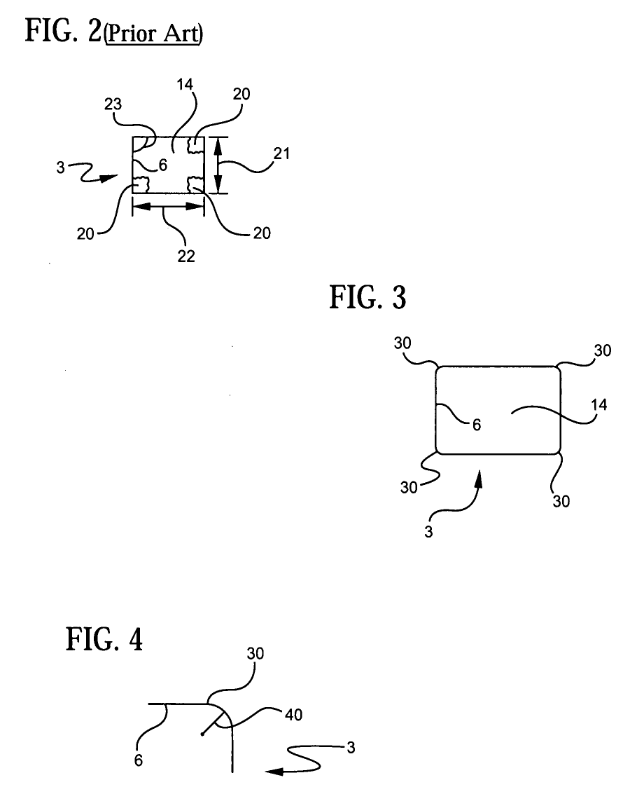

The chute 3/hopper 4 combination is shown to be upright (essentially vertical), and can be of a height length 12 of about 4.5 feet, with chute 11 being of a height length of about 11 feet. Chute 3 can have a sharp-angled, transverse cross-section of a configuration and size as shown, for example, in FIG. 2.

In operation, mixer 2 receives solid polymer particles and subjects those particles to severe mixing until their temperature is raised at least to their melting point, as described in greater detail hereinabove. The now molten polymer then passes into the open interior 14 of chute 3 in which it flows downwardly as shown by arrow 13 into the open interior 15 of hopper 4. The operation of the mixer is controlled so that; in combination with the rate of flow of molten polymer through chute 3, hopper 4, and extruder 5; the upper polymer level 10 of the body of molten polymer maintained in hopper 4 is just above the top of extruder screw 7.

If level 10 is too high, the polymer can harden and cause extrusion problems. If level 10 is below the top of screw 7, the cushioning effect provided by a screw that is full of molten polymer is reduced, and can thereby cause surging of the screw with resultant undesired metal to metal rubbing and/or metal to metal impacting. A nitrogen blanket is maintained in the interior volumes 14 and 15 of chute 3 and hopper 4, respectively, to prevent the incursion of air because oxygen can negatively affect the quality of the polymer. This nitrogen purge reduces the formation of black specs that find their way into the polymer, but does not altogether eliminate their formation, as does this invention.

FIG. 2 shows the transverse cross-section of chute 3 of FIG. 1. This cross-section is a rectangular polygon with four concave (inwardly directed) 90 degree angles 23. A typical chute/hopper combination, for example, would have a short transverse side dimension 21 of about 18 inches and a long transverse side dimension 22 of about 23 inches, while its associated hopper (not shown, see FIG. 1) would have a short transverse dimension of about 21 inches and a long transverse dimension of about 25 inches.

Molten polymer can hang up in any or all of these sharp, 90 degree corners, as shown at 20. The thus stranded polymer stays in its corner and is subjected to continuous heating from fresh polymer from mixer 2 passing thereby. This prolonged heating causes at least some of the surface of the stranded polymer globs to become charred or otherwise darkened up to and including a black color. Thereafter, small pieces thereof can flake off into fresh, whitish polymer and make their way into extruder 5. The incorporation of these darkened particles into the polymer exiting the extruder at 9 can cause discolored polymer pellets which are undesired as explained above. Stranded polymer 20 can be in a discrete clump and/or in a string that extends along a substantial length, if not all, of the height of the corner in which it resides.

FIG. 3 shows chute 3 modified in accordance with the first aspect of the combination of aspects of this invention in that its sharp angled corners have all been rounded to be concavely curved (inwardly directed toward inner space 14) as shown at 30.

The second aspect of the combination of aspects of this invention is that the inner surface of the rounded corners 30 are, at least in part, smoothed at least to a 125 micron mirror shine, i.e., meeting, at the least, an ASTM R-12 standard. For purposes of this invention, the entirety of the inner surface 6, i.e., the corners plus the straight sides, can be smoothed, or all or any portion of just the corners can be smoothed to the smoothness standard of this invention as set forth above. The level of smoothness for this invention can be achieved by conventional polishing of the desired portion or portions of inner surface 6, be it a corner, straight side, or both. The level of smoothness for this invention can also be achieved by other means known in the art such as conventional electroplating of the desired portion or portions of the corners and straight sides with chromium, nickel, and the like

FIG. 4 shows an enlargement of a single rounded corner of the chute of FIG. 3 to better show the radius of curvature 40 of that corner. The degree of roundness for the corners pursuant to this invention such as corner 30 can vary depending on the transverse configuration of chute 3, the nature of the polymer flowing through chute 3, and the like, and can readily be determined by one skilled in the art once appraised of this invention. Generally, the rounded concave corners 30 can have a radius of curvature of from about 2 to about 3.5 inches for polygonal, particularly quadrilateral chutes.

I claim:

1. In a method for conveying molten polymer from a first processing unit to a second processing unit wherein said molten polymer passes through an enclosed chute conduit having an inner surface and a polygonal transverse cross-section, said cross-section having a plurality of concave sharp angled corners, the improvement comprising providing said chute with concavely rounded corners, and smoothing at least said inner surface of said corners to meet at least an ASTM R-12 standard, 125 micron mirror smoothness.

2. The method of claim 1 wherein said polymer is polyethylene.

3. The method of claim 2 wherein said polyethylene is high density polyethylene.

4. The method of claim 1 wherein said first processing unit is a high shear mixer, and said second processing unit is an extruder.

5. The method of claim 1 wherein said transverse cross-section is quadrilateral in configuration.

6. The method of claim 1 wherein said rounded corners have a radius of curvature of from about 2 to about 3.5 inches.

7. The method of claim 1 wherein chute is upright with said first processing unit disposed on top of said chute, and said second processing unit disposed below said chute.

8. The method of claim 1 wherein said smoothing is provided by at least one of polishing said inner surface and electroplating said inner surface.
